(19) United States
(12) Patent Application Publication
(10) Pub. No.: US 2026/0234881 A1
(43) Pub. Date: Aug. 13, 2026

(54) PLOW MOUNTING SYSTEM AND METHOD

(71) Applicant: Meyer Products LLC, Mayfield, OH (US)

(72) Inventor: Louis M. Orazem, Chardon, OH (US)

(73) Assignee: Meyer Products LLC, Mayfield, OH (US)

(21) Appl. No.: 19/455,361

(22) Filed: Jan. 21, 2026

Related U.S. Application Data
(60) Provisional application No. 63/757,559, filed on Feb. 12, 2025.

(51) Int. Cl. E01H 5/06; F16B 1/00

(52) U.S. Cl. CPC E01H 5/061; F16B 1/00

(57) ABSTRACT

An accessory mounting assembly is provided for removably attaching an accessory to a vehicle. The assembly includes a frame assembly and a grasping assembly. The frame assembly is for semi-permanent fixation to a vehicle and includes a vehicle fixation portion for fixing to the vehicle and an accessory mounting portion for mounting an accessory onto the frame assembly. The accessory mounting portion includes a lower grabbable element, an upper grabbable element substantially parallel to and spaced apart from the lower grabbable element by a first distance, and at least one locating feature for positioning a grasping assembly. The grasping assembly for grasping the accessory mounting portion of the frame assembly includes at least one lower hook for grasping the lower grabbable element, and at least one upper hook for grasping the upper grabbable element, and an accessory mount for locating an accessory relative to the grasping assembly.

### CROSS-REFERENCE TO RELATED APPLICATIONS

This application claims the benefit of U.S. Provisional Patent Application No. 63/757,559, filed February 12, 2025, the entire contents of which are hereby incorporated by reference.

### FIELD OF THE INVENTION

The present invention relates to a mounting device for attaching an accessory, such as a plow, to a vehicle, such as a truck.

### BACKGROUND

Various mounting devices and assemblies exist for mounting accessories, such as plows, to vehicles. However, many existing mounting structures are difficult to use, particularly for consumers unfamiliar with mounting accessories on their vehicles.

Existing mounting assemblies typically require precise alignment between a vehicle and an accessory to be mounted. Accordingly, it is often difficult to position the vehicle, and users typically require a second person to work as a spotter, or may need to drive the vehicle into position and then exit and reenter the vehicle multiple times to make fine adjustments to their position.

Further, existing mounting assemblies typically require pins or levers to fix the accessory to the vehicle. Such mounting assemblies are used by first positioning the vehicle relative to the accessory by aligning a pin hole at which the assembly is to be mounted. Once positioned, a pin is released to lock the accessory in place. However, such use of pins typically requires an additional locking step and, as noted above, requires extremely precise alignment prior to locking the accessory in place.

Existing mounting assemblies have been designed to avoid the need for such a fine alignment by providing a V shaped mounting structure along with aggressively angled clamps designed to center themselves on the mounting structure. However, such a mounting structure was extremely heavy and difficult to manufacture.

Further, it required multiple components to be manufactured and/or assembled at precise angles. Further, because the actual mounting surfaces were angled, the stability of the overall mounted structure was inherently limited.

There is a need for a robust mounting system that could allow for the securing of an accessory to a vehicle quickly and easily and with a high tolerance for misalignment. There is a further need for such a system that could be used to mount an accessory without requiring secondary steps, such as the use of mounting pins.

### SUMMARY

In some embodiments, an accessory mounting assembly is provided for removably attaching an accessor to a vehicle. The assembly includes a frame assembly and a grasping assembly.

The frame assembly is for semi-permanent fixation to a vehicle, the frame assembly including a vehicle fixation portion for fixing the frame assembly to the vehicle and an accessory mounting portion for mounting an accessory onto the frame assembly. The accessory mounting portion includes a lower grabbable element, an upper grabbable element substantially parallel to and spaced apart from the lower grabbable element by a first distance, and at least one locating feature for positioning a grasping assembly laterally relative to the frame assembly.

The grasping assembly for grasping the accessory mounting portion of the frame assembly includes at least one lower hook for grasping the lower grabbable element, and at least one upper hook for grasping the upper grabbable element, and an accessory mount for locating an accessory relative to the grasping assembly.

The grasping assembly has an open configuration in which a point of the at least one lower hook is a second distance from a point of the at least one upper hook, the second distance being larger than the first distance, and a closed configuration in which the point of the at least one lower hook is a third distance from the point of the at least one upper hook, the third distance being smaller than the first distance. The grasping assembly is mounted to the frame assembly by transitioning the grasping assembly from the open configuration to the closed configuration such that the at least one lower hook grasps the lower grabbable element and the at least one upper hook grasps the upper grabbable element.

In some embodiments, each of the lower grabbable element and the upper grabbable element extend laterally in a linear direction and have a substantially consistent cross section. In some such embodiments, the substantially consistent cross section of the lower grabbable element is substantially square and the substantially consistent cross section of the upper grabbable element is circular.

In some embodiments having laterally extending grabbable elements, the at least one locating feature is a sloped element adjacent one of the upper grabbable element or the lower grabbable element. Upon transitioning the grasping assembly from the open configuration to the closed configuration, one of the at least one lower hook or the at least one upper hook contacts the at least one locating feature prior to contacting the corresponding grabbable element, such that the grasping assembly is forced to move laterally prior to completing the transition. In some such embodiments, the at least one locating feature is two locating features located adjacent opposite ends of the upper grabbable element, and each locating feature is sloped towards a center of the upper grabbable element.

In some such embodiments, the at least one upper hook is two upper hooks spaced apart from each other laterally, and a space between outer surfaces of the two upper hooks corresponds substantially to a space between the two locating features, and when the grasping assembly is in the closed configuration and mounted on the frame assembly, each upper hook grasps the upper grabbable element and is located adjacent the corresponding locating feature.

In some embodiments having laterally extending grabbable elements, the at least one lower hook is two lower hooks spaced apart from each other laterally, and when the grasping assembly is in the closed position and mounted on the frame assembly, each lower hook grasps the lower grabbable element and is located adjacent opposite ends of the lower grabbable element. In some such embodiments, the frame assembly further includes side panels locating the lower grabbable element relative to the upper grabbable element, where the side panels define lateral ends of the lower grabbable element and the upper grabbable element, and where each of the two lower hooks comprise a sloped surface angled in opposite directions, and where upon transitioning the grasping assembly from the open configuration to the closed configuration, the sloped surface of one of the two lower hooks contacts a corresponding side panel prior to contacting the lower grabbable element, such that the grasping assembly is forced to move laterally prior to completing the transition.

In some such embodiments, the at least one locating feature is two sloped elements adjacent opposite ends of the upper grabbable element, each adjacent the corresponding side panel. Upon transitioning the grasping assembly from the open configuration to the closed configuration, the at least one upper hook contacts one of the two sloped elements prior to contacting upper grabbable element, such that the grasping assembly is forced to move laterally by the combination of the corresponding sloped element and the sloped surface of one of the two lower hooks prior to completing the transition.

In some embodiments, the assembly includes an accessory fixed to the grasping assembly by way of the accessory mount. In some such embodiments, the accessory is a plow.

In some embodiments including an accessory, the accessory is fixed to the grasping assembly by way of a rotatable connection, the rotatable connection allowing the accessory to pivot laterally relative to the vehicle. In some such embodiments, the assembly further includes a pair of linear actuators extending from opposite sides of the grasping assembly to opposite sides of the accessory at the rotatable connection, wherein actuation of the linear actuators effectuates a lateral pivot of the accessory.

In some embodiments including an accessory, when the frame assembly is mounted to a vehicle and when the grasping assembly is in a closed configuration and grasping the grabbable elements, the accessory is suspended relative to a surface.

In some embodiments including an accessory, the accessory is fixed to the grasping assembly by way of the accessory mount, where the accessory mount comprises a truss structure extending from the grasping assembly to an accessory mount location and for spacing the accessory apart from the grasping assembly.

In some such embodiments, the truss structure is rotatably fixed to the grasping assembly such that pivoting the truss structure relative to the grasping assembly raises or lowers the accessory fixed thereto. In some such embodiments, the truss structure extends substantially horizontally from the grasping assembly and pivots relative thereto.

In some embodiments utilizing a truss structure, the accessory is fixed to the truss structure at the accessory mount by way of a rotatable connection, the rotatable connection allowing a plow blade to pivot laterally relative to the vehicle.

In some embodiments utilizing a truss structure, the truss structure extends from a bottom of the grasping assembly and further comprising a lift unit extending from a top of the grasping assembly to the truss structure adjacent the accessory mounting location, and wherein the lift unit pivots the truss structure relative to the grasping assembly. In some such embodiments, the lift unit is hydraulically operated.

In some embodiments, a transition between the open and closed configurations is actuated by a hydraulically operated piston.

In some embodiments, at least one of the at least one lower hook and the at least one upper hook further includes a protective insert formed from a low friction material for engagement with the corresponding grabbable element.

Also provided is a method for mounting an accessory to a vehicle. The method includes fixing a frame assembly semi-permanently to a vehicle at a vehicle fixation portion of the frame assembly, the frame assembly including an accessory mounting portion having a lower grabbable element and an upper grabbable element substantially parallel to and spaced apart from the lower grabbable element by a first distance.

The method then includes providing at least one locating feature at the accessory mounting portion, the locating feature including a sloped element adjacent one of the upper grabbable element or the lower grabbable element.

The method then includes providing a grasping assembly having at least one lower hook for grasping the lower grabbable element and at least one upper hook for grasping the upper grabbable element.

The method then includes providing an accessory fixed to the grasping assembly.

The method then includes positioning the grasping assembly in an open configuration in which a point of the at least one lower hook is spaced apart from a point of the at least one upper hook by a second distance larger than the first distance.

The method then further includes operating the vehicle so as to position the lower grabbable element and the upper grabbable element of the accessory mounting portion of the frame assembly between the at least one lower hook and the at least one upper hook, actuating a transition of the grasping assembly to a closed configuration in which the point of the at least one lower hook is spaced apart from the point of the at least one upper hook by a third distance smaller than the first distance, causing the at least one lower hook or the at least one upper hook to impact the at least one locating feature, thereby forcing the grasping assembly to shift laterally, and continuing to transition the grasping assembly to the closed configuration until the at least one lower hook grasps the lower grabbable element and the at least one upper hook grasps the upper grabbable element.

In some embodiments, the transition of the grasping assembly to the closed configuration raises the accessory off of a surface on which it was resting.

In some embodiments, the accessory is a plow.

In some embodiments, each of the lower grabbable element and the upper grabbable element extend laterally in a linear direction and have a substantially consistent cross section.

In some such embodiments, the at least one locating feature is two locating features located adjacent opposite ends of the upper grabbable element, and each locating feature is sloped towards a center of the upper grabbable element.

In some such embodiments, the at least one upper hook is two upper hooks spaced apart from each other laterally, and a space between outer surfaces of the two upper hooks corresponds substantially to a space between the two locating features, and where when the grasping assembly is in the closed position and mounted on the frame assembly, each upper hook grasps the upper grabbable element and is located adjacent the corresponding locating feature.

In some embodiments, the at least one lower hook is two lower hooks spaced apart from each other laterally, and wherein when the grasping assembly is in the closed position and mounted on the frame assembly, each lower hook grasps the lower grabbable element and is located adjacent opposite ends of the lower grabbable element.

In some such embodiments, the frame assembly further includes side panels locating the lower grabbable element relative to the upper grabbable element, where the side panels define lateral ends of the lower grabbable element and the upper grabbable element, wherein each of the two lower hooks comprise a sloped surface angled in opposite directions, and where transitioning the grasping assembly from the open configuration to the closed configuration, the sloped surface of one of the two lower hooks contacts a corresponding side panel prior to contacting the lower grabbable element, thereby forcing the grasping assembly to move laterally prior to completing the transition.

### BRIEF DESCRIPTION OF THE DRAWINGS

FIG. 1 is a perspective view of a frame assembly for use in an accessory mounting assembly in accordance with this disclosure.

FIG. 2 is a front view of the frame assembly of FIG. 1.

FIG. 3 is a front perspective view of a grasping assembly for use in the accessory mounting assembly in accordance with this disclosure.

FIG. 4 is a rear perspective view of the grasping assembly of FIG. 3.

FIG. 5 is a front perspective view of the grasping assembly of FIG. 3 with an accessory mount.

FIG. 6 is a side view of the grasping assembly and accessory mount of FIG. 5 in an open configuration prior to mounting on the frame assembly of FIG. 1.

FIG. 7 shows the components of FIG. 6 positioned for mounting.

FIG. 8 shows a front perspective view of the components of FIG. 6 following mounting.

FIG. 9 shows a side view of the components of FIG. 6 following mounting.

FIG. 10 shows a rear perspective view of the components of FIG. 6 following mounting.

FIG. 11 shows a front view of the components of FIG. 6 following mounting.

FIG. 12 shows a side sectioned view of the components of FIG. 6 following mounting.

FIG. 13 shows a front perspective view of the components of FIG. 6 with an accessory installed thereon following mounting.

FIG. 14 shows a side view of the components of FIG. 13 following mounting.

FIG. 15 shows a top view of the components of FIG. 13 following mounting.

FIG. 16 shows a perspective view of the frame assembly of FIG. 1 installed on a truck with the grasping assembly of FIG. 3 dismounted and in an open configuration.

FIG. 17 shows a side view of the frame assembly of FIG. 1 installed on a truck with the grasping assembly of FIG. 3 in the open configuration and positioned for mounting.

FIG. 18 shows the components of FIG. 17 with the grasping assembly in the closed configuration and mounted on the frame assembly.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

An accessory mounting assembly 100 is provided for removably attaching an accessory 1300 to a vehicle 1600. The assembly 100 typically has a frame assembly 110, a grasping assembly 300 for grasping elements of the frame assembly 110, and an accessory mount 500 for locating the accessory 1300 relative to the grasping assembly 300.

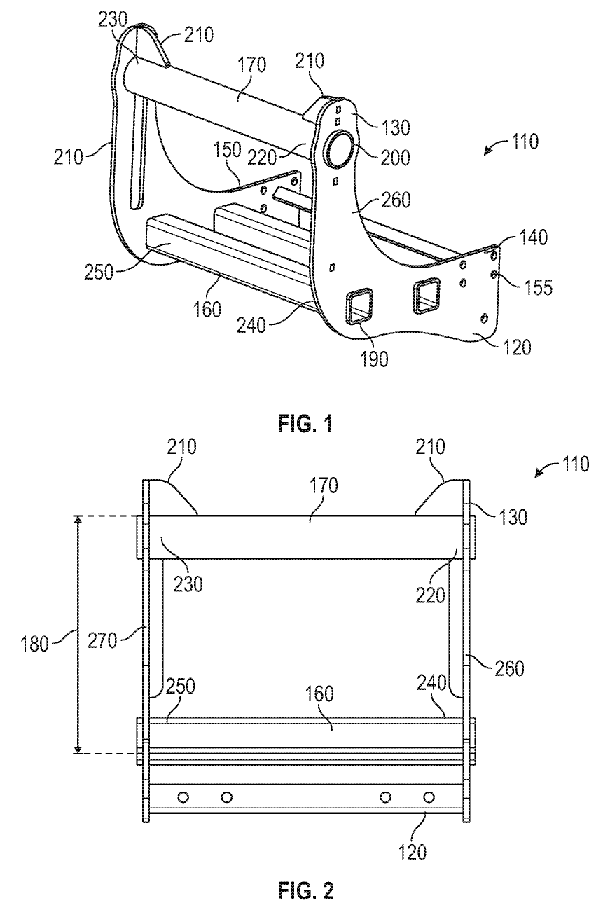

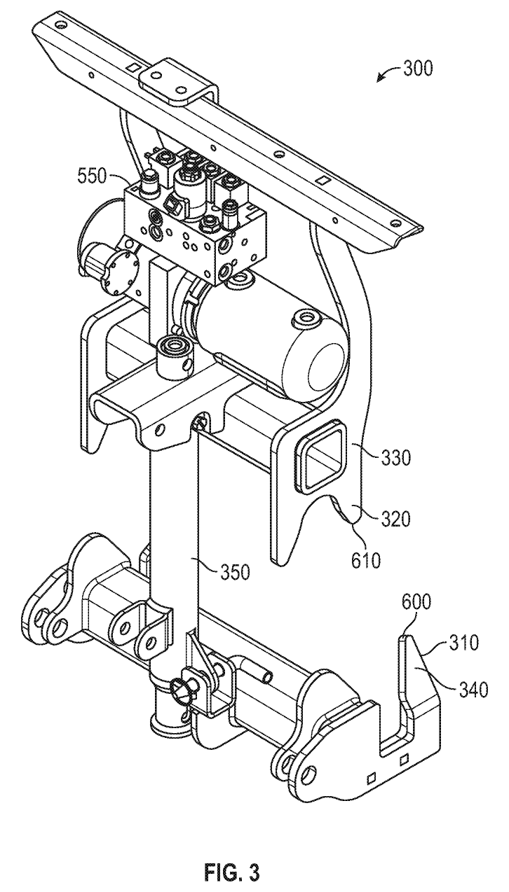

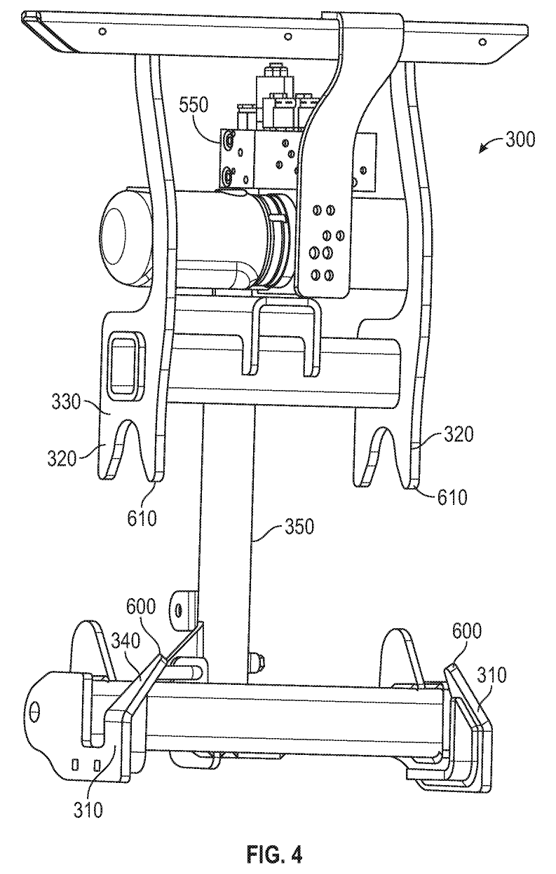

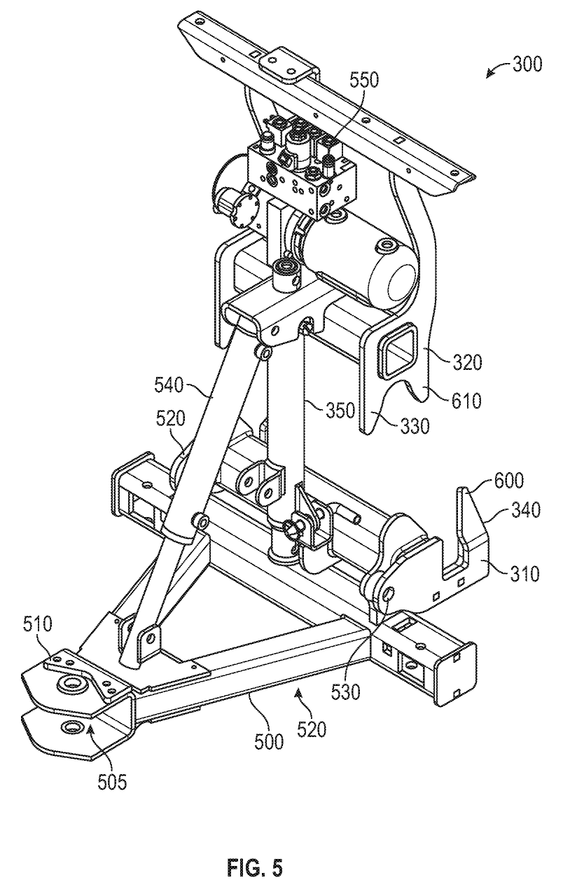

FIG. 1 is a perspective view and FIG. 2 is a side view of a frame assembly 110 for use in an accessory mounting assembly. FIG. 3 is a front perspective view and FIG. 3 is a rear perspective view of a grasping assembly 300 for use in the accessory mounting assembly. FIG. 5 is a front perspective view of the grasping assembly 300 of FIG. 3 with an accessory mount 500.

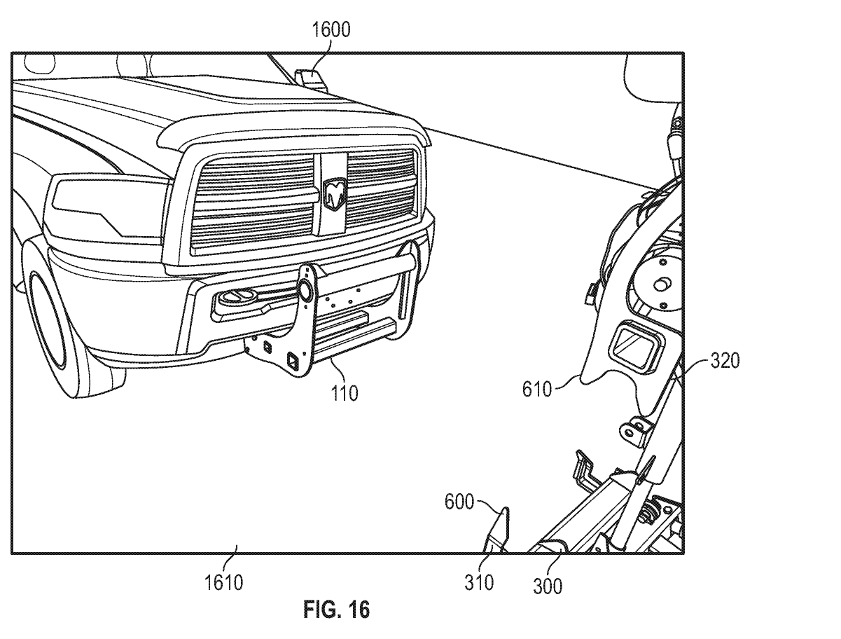

As shown in FIGS. 16-18, the frame assembly 110 is for semi-permanent fixation to a vehicle 1600, such as a truck. The frame assembly therefore has a vehicle fixation portion 120 for fixing the frame assembly 110 to the vehicle, and also has an accessory mounting portion 130 for mounting an accessory 1300 onto the frame assembly 110.

The vehicle fixation portion 120 comprises a pair of arms 140, 150 which extend from the accessory mounting portion 130 in a substantially perpendicular direction. The arms 140, 150 each have mounting holes 155 located therein which are then used to bolt the frame assembly 110 to the vehicle 1600. The mounting holes 155 may be located to mate with a standard connection on a vehicle 1600. When mounted, the arms 140, 150 extend from the vehicle substantially horizontally, and the mounting portion 130 extends upwards from the vehicle fixation portion 120. Accordingly, while the vehicle fixation portion 120 does mount on a bottom portion of the vehicle 1600, the horizontal nature of the arms 140, 150 avoids reducing the vehicle’s ground clearance unnecessarily.

The accessory mounting portion 130 then includes a lower grabbable element 160 and an upper grabbable element 170. The upper grabbable element 170 is substantially parallel to the lower grabbable element 160 and is spaced apart therefrom by a first distance 180. Each of the lower grabbable element 160 and the upper grabbable element 170 typically extend laterally in a linear direction and have a substantially consistent cross section 190, 200. In the embodiment shown, the substantially consistent cross section 190 of the lower grabbable element 160 is substantially square, while the substantially consistent cross section 200 of the upper grabbable element 170 is circular. As shown, the lower grabbable element 160 may have a cross section 190 with rounded corners and may thereby not be precisely square.

The accessory mounting portion 130 further includes at least one locating feature 210 for positioning a grasping assembly 130 laterally relative to the frame assembly 110. The locating feature 210 may be a sloped element adjacent one of the upper grabbable element or the lower grabbable element. In the embodiment shown, the at least one locating feature 210 is two sloped elements located adjacent opposite ends 220, 230 of the upper grabbable element 170. Each locating feature 210 is then sloped towards a center of the upper grabbable element 170.

It is noted that, while the accessory mounting portion 130 is substantially perpendicular to the vehicle fixation portion 130, it is not necessarily precisely perpendicular thereto. Accordingly, as shown, while the upper grabbable element 170 is spaced apart from the lower grabbable element 160 by a first distance 180, the first distance 180 may be measured in a vertical direction, while the grabbable elements may also be offset in a horizontal direction. This offset may be in order to allow the frame assembly 110 to better conform to a shape of a vehicle 1600 when mounted, or it may be in order to provide better positioning of the grabbable elements 170, 180 during the mounting process. The offset may similarly be provided in order to improve the mechanical stability of the accessory mounting assembly 100 as a whole, such as by providing increased leverage for components during use.

The grasping assembly 300 is for grasping the accessory mounting portion 130 of the frame assembly 110. The grasping assembly 300 includes at least one lower hook 310 for grasping the lower grabbable element 160 and at least one upper hook 320 for grasping the upper grabbable element 180. The grasping assembly 300 is then mated to an accessory mount 500 which is then used to locate an accessory 1300 relative to the grasping assembly 300.

As shown, the grasping assembly 300 may include two lower hooks 310 and two upper hooks 320. When installed, the two lower hooks 310 are then mated to the lower grabbable element 170 and the two upper hooks 320 are mated to the upper grabbable element 180. It is noted that while the hooks 310, 320 are referred to herein as hooks, they could similarly be provided as cradles or other structures shaped to retain the corresponding grabbable element. Accordingly, the lower hooks 310 and the upper hooks 320 may differ in shape in the embodiment shown, but are both designed to grasp and retain the respective grabbable elements 160, 170.

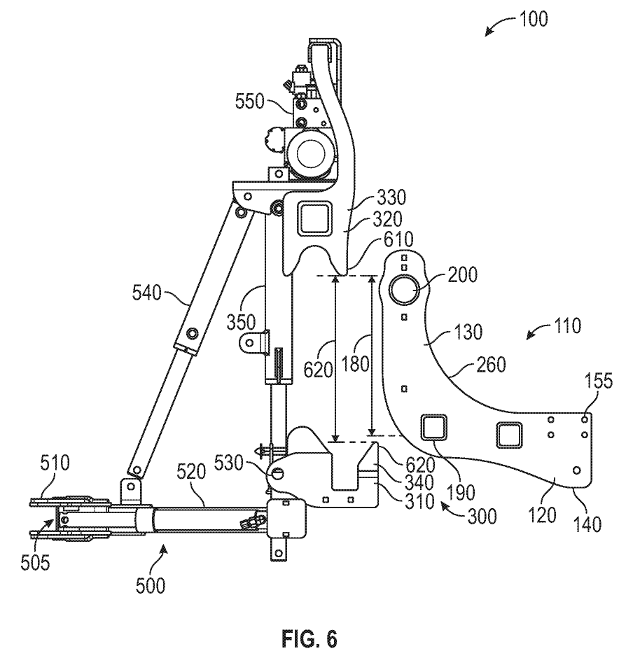

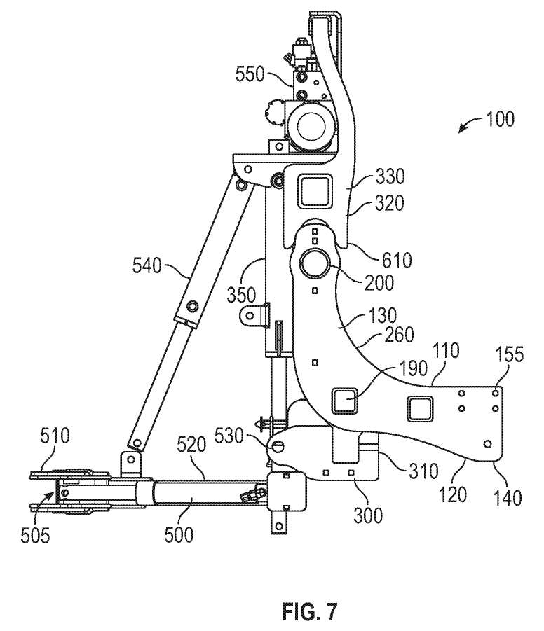

FIG. 6 is a side view of the grasping assembly 300 and accessory mount 500 of FIG. 5 in an open configuration prior to mounting on the frame assembly 110 of FIG. 1, together comprising the accessory mounting assembly 100. FIG. 7 shows the components of the accessory mounting assembly 100 of FIG. 6 positioned for mounting.

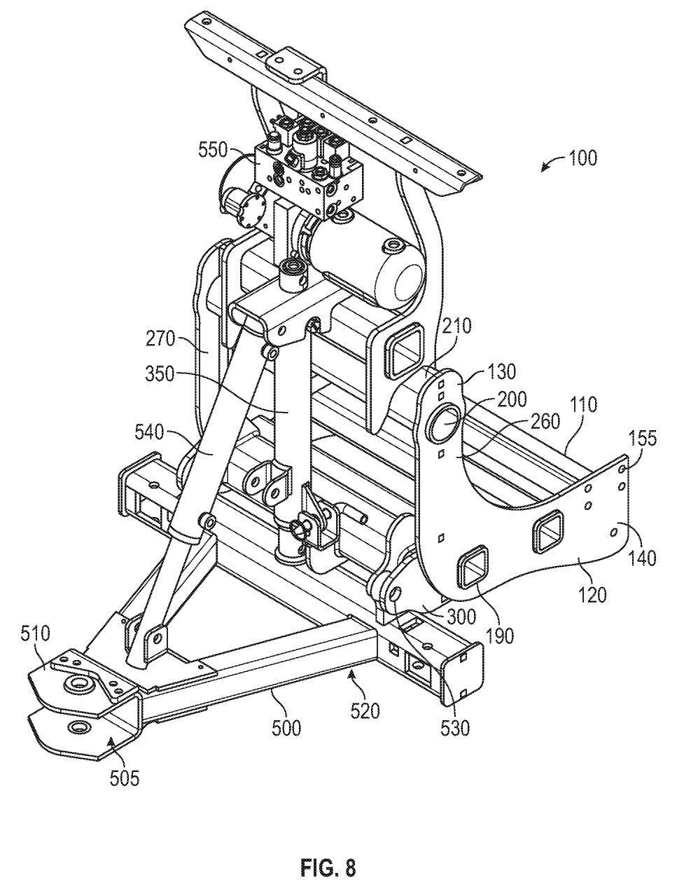

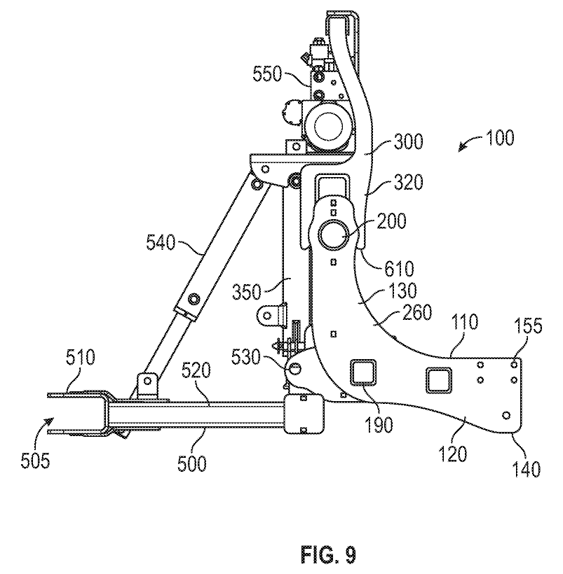

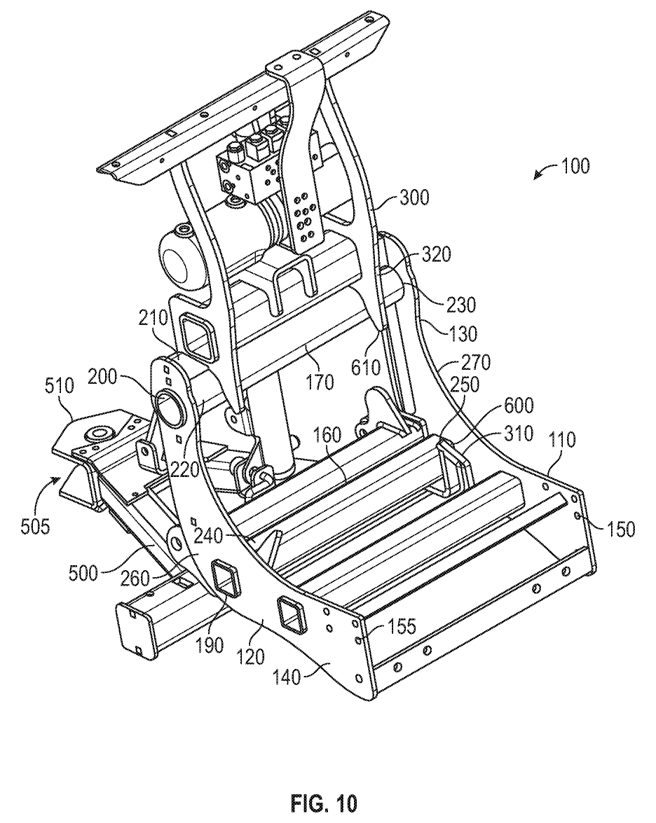

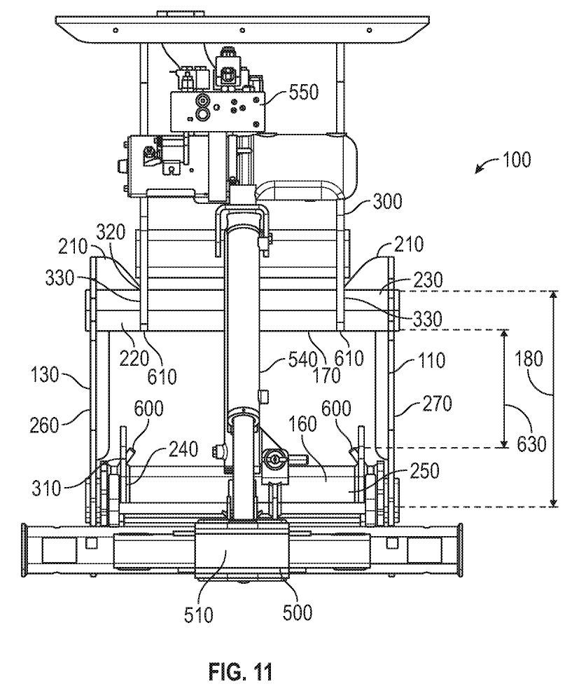

FIG. 8 shows a front perspective view, FIG. 9 shows a side view, FIG. 10 shows a rear perspective view, and FIG. 11 shows a front view of the components of the accessory mounting assembly 100 of FIG. 6 following mounting.

The grasping assembly 300 has an open configuration, as shown in FIGS. 6 and 7 and a closed configuration, as shown in FIGS. 8-11 and other figures. In the open configuration, a point 600 of the at least one lower hook 310, in this case two hooks, is spaced apart from a point 610 of the at least one upper hook 320, in this case two hooks, by a second distance 620. The second distance 620 is larger than the first distance 180. In the closed configuration, the points 600 of the lower hooks 310 are spaced apart from the points 610 of the upper hooks 320 by a third distance 630 smaller than the first distance 180.

Accordingly, the grasping assembly 300 is mounted to the frame assembly 110 by transitioning the grasping assembly 300 from the open configuration of FIGS. 6 and 7 to the closed configuration of FIGS. 8-11. During this transition, the at least one lower hook 310 grabs the lower grabbable element 160 and the at least one upper hook 320 grabs the upper grabbable element 170.

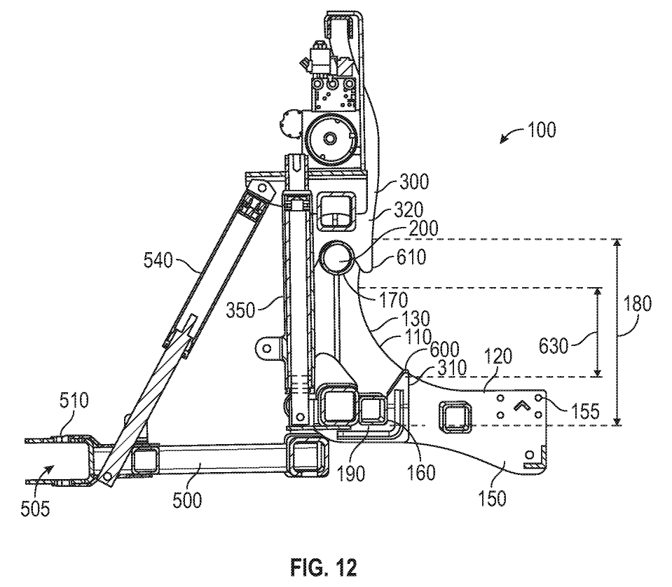

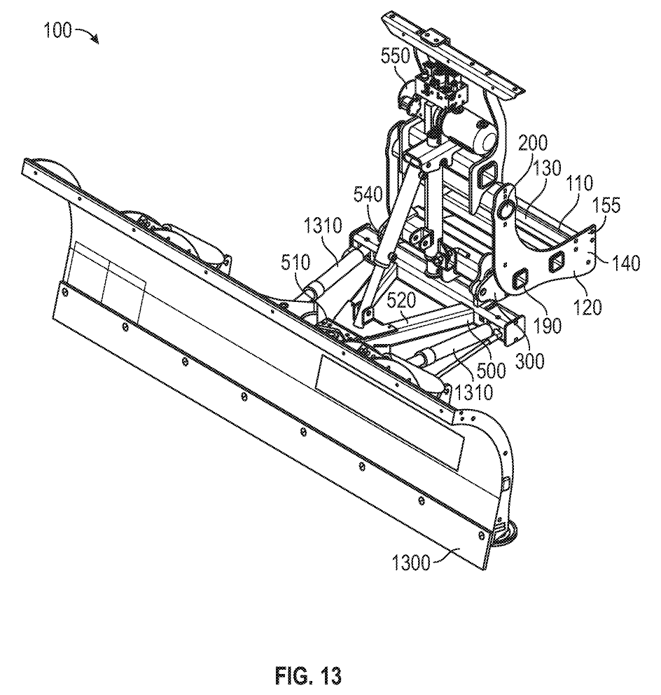

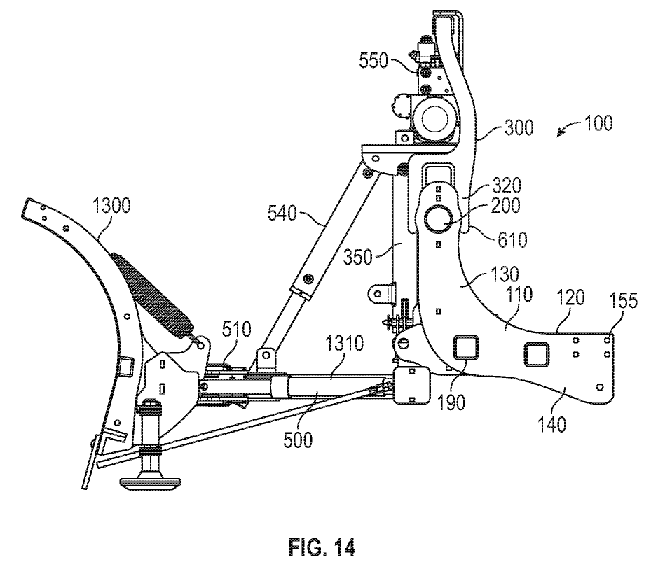

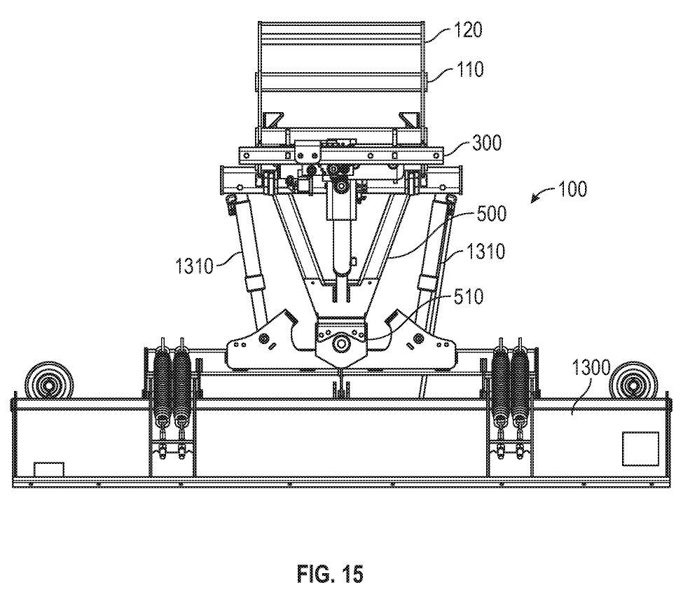

FIG. 12 shows a side sectioned view of the components of the accessory mounting assembly 100 of FIG. 6 following mounting. FIG. 13 shows a front perspective view, FIG. 14 shows a side view, and FIG. 15 shows a top view of the components of the accessory mounting assembly 100 of FIG. 6 with an accessory 1300 installed thereon following mounting.

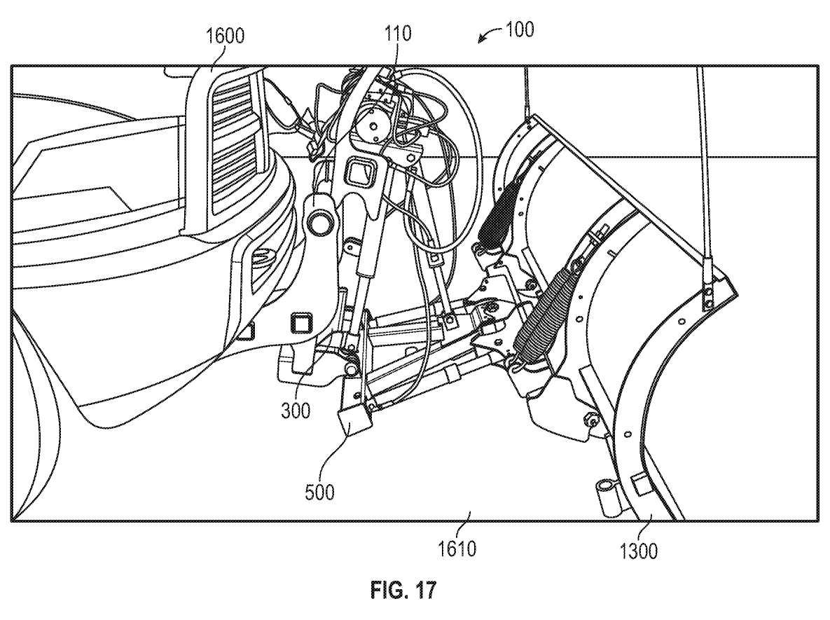

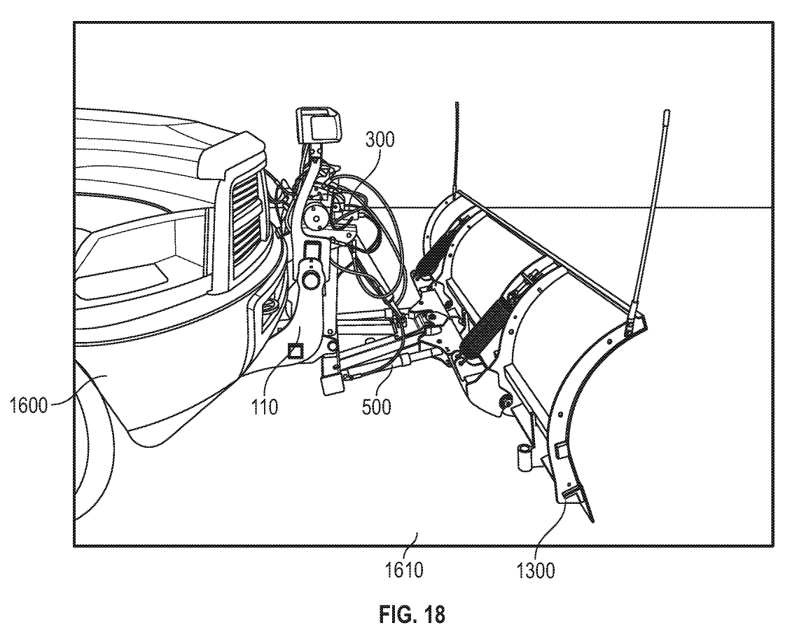

FIG. 16 shows a perspective view of the frame assembly 110 of FIG. 1 installed on a truck 1600 with the grasping assembly 300 of FIG. 3 dismounted and in an open configuration. FIG. 17 shows a side view of the frame assembly 100 of FIG. 1 installed on the truck 1600 with the grasping assembly 300 of FIG. 3 in the open configuration and positioned for mounting. FIG. 18 shows the components of FIG. 17 with the grasping assembly 300 in the closed configuration and mounted on the frame assembly 100.

Because the second distance 620 is larger than the first distance 180, the grasping assembly 300 can be repositioned relative to the frame assembly 110 when in the open configuration. Accordingly, the grasping assembly 300 is designed so as to have a resting position or a stand which positions the hooks 310, 320 at a height relative to a height of the frame assembly 110 when mounted on a vehicle 1600. In such a position, the grasping assembly 300 may be initially provided in its open configuration, and the points 600 of the lower hooks 310 may be positioned below the lower grabbable element 160 when considered relative to a ground surface 1610. Similarly, the points 610 of the upper hooks 320 may be positioned above the upper grabbable element 170 when considered relative to the ground surface 1620.

Accordingly, as shown in FIGS. 16-18, when the grasping assembly 300 in the open configuration and when the frame assembly 110 is mounted on a vehicle 1600, the vehicle 1600 may be driven into position, such that the hooks 310, 320 of the grasping assembly 300 surround the grabbable elements 160, 170 of the frame assembly 110.

The grasping assembly 300 is then transitioned to the closed assembly. During such a transition, the lower hooks 310 and the upper hooks 320 are drawn towards each other until they grasp the corresponding grabbable elements 160, 170. During such a transition, of the elements are not properly aligned, one of the hooks 310, 320 may impact, or otherwise contact, the at least one locating feature 210 prior to contacting the corresponding grabbable element 160, 170. The grasping assembly 300 is then forced to move laterally prior to completing the transition to the closed configuration. In the embodiment shown, the locating feature 210 is two locating features located adjacent opposite ends 220, 230 of the upper grabbable element 170. The locating features 310 are then sloped elements, and each is sloped towards a center of the upper grabbable element 170.

The at least one upper hook 320 is then two upper hooks spaced apart from each other laterally. A space between outer surfaces 330 of the two upper hooks 320 then corresponds substantially to a space between the two locating features 210. When transitioning from the open configuration to the closed configuration, either of the upper hooks 320 may then impact or otherwise contact the corresponding locating feature 210, thereby forcing the grasping assembly 300 to move laterally relative to the frame assembly 110. Once mounted on the frame assembly 110 and in the closed configuration, each upper hook 320 of the grasping assembly 300 grasps the upper grabbable element 170 at a location adjacent the corresponding locating feature 210.

The at least one lower hook 310 may similarly be two hooks spaced apart from each other laterally. As shown, when the grasping assembly 300 is in the closed position and mounted on the frame assembly 110, each lower hook 310 may grasp the lower grabbable element 160 and be located adjacent opposite ends 240, 250 of the lower grabbable element.

As shown, the frame assembly 110 may further include side panels 260, 270 which locate the lower grabbable element 160 relative to the upper grabbable element 170. The side panels 260, 270 may then define the lateral ends 240, 250 of the lower grabbable element 160 and the lateral ends 220, 230 of the upper grabbable element 170. The side panels 260, 270 may then work in concert with centering features of the grasping assembly 300 in order to ensure alignment of the accessory mounting assembly 100 as a whole during mounting.

As shown, each of the two lower hooks 310 may comprise a sloped surface 340 angled in opposite directions. During a transition of the grasping assembly 300 from the open configuration to the closed configuration, the sloped surface 340 of one of the lower hooks 310 may then impact or otherwise contact the corresponding side panel 260, 270 prior to contacting the lower grabbable element 160, thereby forcing the grasping assembly 300 to move laterally prior to completing the transition. In some embodiments, one or more of the hooks 310, 320 may be provided with a protective insert (not shown). Such an insert may be formed from a material softer than the hooks, so as to avoid scratching or otherwise damaging components when alignment is imperfect. Such an insert may be formed from a low friction material so as to improve engagement with the corresponding grabbable element 160, 170.

In some embodiments, this centering feature may work in concert with the locating feature 210 discussed above. Accordingly, as shown, the locating feature 210 may be two sloped elements adjacent opposite ends of the upper grabbable element 170, each adjacent the corresponding side panel 260, 270 at the corresponding lateral ends 220, 230 of the upper grabbable element. Upon transitioning the grasping assembly 300 from the open configuration to the closed configuration, an upper hook 320 may contact a corresponding locating feature 210 while a sloped surface 340 of a lower hook 310 simultaneously contacts the corresponding side panel 260, 270. The combination of the corresponding sloped element 210 and the corresponding sloped surface 340 thereby work in concert to force the grasping assembly 300 to move laterally prior to completing the transition to the closed configuration.

As shown, the grasping assembly 300 may be provided with a linear actuator 350 for defining a space between the lower hooks 310 and the upper hooks 320. Such a linear actuator 350 may be, for example, a hydraulically operated piston. As such, the grasping assembly 300 may be hydraulically operated so as to transition between the configurations discussed herein.

Once the grasping assembly 300 is transitioned to the closed configuration, the grasping assembly is typically mounted onto the frame assembly 110 thereby completing the accessory mounting assembly 100. When the frame assembly 110 is mounted on a vehicle, 1600, the vehicle may then be used to manipulate and utilize the accessory 1300 mounted thereon. Typically, when the frame assembly 110 is mounted to a vehicle 1600 and once the transition to the closed configuration is complete, the accessory 1300 is then suspended relative to the ground surface 1610 that the vehicle 1600 is located on, and can therefore be more easily manipulated. The accessory 1300 may then be raised and lowered as discussed in more detail below.

As shown in FIG. 13, an accessory 1300 is mounted to the grasping assembly 300 by way of the accessory mount 500. The accessory may be, e.g., a plow 1300 as in the embodiment shown. Alternatively, the accessory may be any number of accessories to be mounted at a front of a vehicle, such as a hitch, a rotary broom, and a sweeper.

As shown, the accessory mount 500 may include a rotatable connection 510 configured to allow for lateral pivoting of the accessory 1300. Accordingly, once the accessory 1300 is fixed to the grasping assembly 300 by way of the rotatable connection 510 of the accessory mount 500, the accessory may pivot laterally relative to the vehicle 1600. In order to facilitate such pivoting, the accessory mounting assembly 100 may include a pair of linear actuators 1310 connecting the accessory 1300 to the accessory mount 500 or the grasping assembly 300. Accordingly, the linear actuators 1310 may work in concert to effectuate a lateral pivot of the accessory 1300.

The accessory 1300 may be fixed to the grasping assembly 300 by way of an accessory mount 500 as discussed above. The assembly 100 may then include a truss structure 520 extending from the grasping assembly 300 to the accessory mount location 505. The truss structure 520 in the embodiment shown is rotatably fixed to the grasping assembly 300 at a pivoting connection 530 such that the pivoting the truss structure 520 relative to the grasping assembly 300 raises or lowers the accessory 1300 fixed thereto. At rest, the truss structure 520 may then extend substantially horizontally from the grasping assembly 300 and pivots relative thereto.

As shown, the truss structure 520 may extend from a bottom of the grasping assembly 300. In the embodiment shown, the truss structure 520 is suspended from the pivoting connection 530, and is thereby positioned below the grasping assembly. However, in other embodiments, the truss structure may be positioned adjacent a bottom end of the grasping assembly 300. In any event, the accessory mounting assembly 100 may further include a lift unit 540 extending from a top of the grasping assembly 300 to the truss structure 520 adjacent the accessory mounting location 505. The lift unit may then be configured to lift or lower the far end of the truss structure 520, thereby pivoting the truss structure 520 relative to the grasping assembly 300 and lifting and lowering the accessory mounting location 505 and any accessory 1300 mounted thereon.

The lift unit 540 may be, e.g., a linear actuator and may be hydraulically operated. Similarly, the linear actuators 1310 used for moving the accessory 1300 laterally may similarly be hydraulically operated and the linear actuator 350 for controlling a space between the lower hooks 310 and the upper hooks 320 may be hydraulically operated. Accordingly, a hydraulic unit 550 may be provided to operate any such hydraulically operated actuators utilized in the accessory mounting assembly 100.

As noted above, the accessory 1300 may then be mounted to the accessory mount 500 at an end of the truss structure 520 opposite the grasping assembly 300 by way of the rotatable connection 510. Accordingly, the accessory 1300 may be raised and lowered relative to the ground surface 1610 by way of the truss structure 520 and may be maneuvered laterally by way of the rotatable connection 510 using the linear actuators 1310. In some embodiments, additional adjustments may be implemented by way of the accessory mount 500. For example, an actuator may be added to allow for the accessory to rotate about a longitudinal axis of the vehicle, thereby adding an additional degree of freedom.

In order to mount the accessory 1300 to the vehicle 1600, a method may be utilized. In such a method, the frame assembly 110 may first be fixed to the vehicle. Such a fixation may be semi-permanent. For example, the frame assembly 110 may remain fixed to the vehicle 1600 indefinitely, or it may be installed seasonally. Accordingly, if the accessory 1300 is a plow, as shown, the frame assembly 110 may be installed once for the entirety of the snowy season.

The frame assembly 110, as discussed above, may include a vehicle fixation portion 120 by which it is fixed to the vehicle 1600 and an accessory mounting portion 130. The accessory mounting portion has a lower grabbable element 160 and an upper grabbable element 170 spaced apart from the lower grabbable element by a first distance 180. The grabbable elements 160, 170 may each extend laterally in a linear direction and may have a substantially consistent cross section 190, 200. As such, they may extend in parallel with each other.

At least one locating feature 210 is then provided at the accessory mounting portion 130 of the frame assembly 110. The locating feature 210 has a sloped element and is located adjacent one of the upper grabbable element 170 and the lower grabbable element 160.

A grasping assembly 300 is then provided having at least one lower hook 310 for grasping the lower grabbable element 160 and at least one upper hook 320 for grasping the upper grabbable element 170. As noted above, in the embodiment shown, the grasping assembly 300 has two lower hooks 310 and two upper hooks 320. An accessory 1300 is provided with or is fixed to the grasping assembly 300. The accessory 1300 may be, for example, a plow.

The grasping assembly 300 is then positioned in an open configuration in which a point 600 of the at least one lower hook 310 is spaced apart from a point 610 of the at least one upper hook 320 by a second distance 620 larger than the first distance 180.

The vehicle 1600 on which the frame assembly 110 is mounted is then operated so as to position the lower grabbable element 160 and the upper grabbable element 170 of the accessory mounting portion 130 of the frame assembly 110 between the at least one lower hook 310 and the at least one upper hook 320.

The method then proceeds with actuating a transition of the grasping assembly 300 from the open configuration to the closed configuration. This may be by way of a linear actuator 350 which may be used to control a distance between the lower and upper hooks 310, 320 and which may be operated hydraulically. In the closed configuration, the point 600 of the lower hook 310 is spaced apart from the point 610 of the upper hook 320 by a third distance 630 smaller than the first distance 180.

During such a transition, a misalignment causes the at least one lower hook 310 or the at least one upper hook 320 to impact the at least one locating feature 210. This impact forces the grasping assembly 300 to shift laterally. The method then proceeds with continuing to transition of the grasping assembly 300 to the closed configuration until the at least one lower hook 310 grasps the lower grabbable element 160 and the at least one upper hook 320 grasps the upper grabbable element 170.

As noted above, the transition of the grasping assembly 300 to the closed configuration may raise the accessory 1300 off of a surface 1610 on which it was resting.

Other aspects of the structure of the accessory mounting assembly 100 utilized in the method described herein may correspond to those discussed above.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An accessory mounting assembly for removably attaching an accessory to a vehicle, the assembly comprising:
a frame assembly for semi-permanent fixation to a vehicle, the frame assembly including a vehicle fixation portion for fixing the frame assembly to the vehicle and an accessory mounting portion for mounting an accessory onto the frame assembly, wherein the accessory mounting portion comprises:
a lower grabbable element;
an upper grabbable element substantially parallel to and spaced apart from the lower grabbable element by a first distance; and
at least one locating feature for positioning a grasping assembly laterally relative to the frame assembly, and
the grasping assembly for grasping the accessory mounting portion of the frame assembly, the grasping assembly comprising:
at least one lower hook for grasping the lower grabbable element; and
at least one upper hook for grasping the upper grabbable element, and
an accessory mount for locating an accessory relative to the grasping assembly,
wherein the grasping assembly has an open configuration in which a point of the at least one lower hook is a second distance from a point of the at least one upper hook, the second distance being larger than the first distance, and a closed configuration in which the point of the at least one lower hook is a third distance from the point of the at least one upper hook, the third distance being smaller than the first distance, and wherein the grasping assembly is mounted to the frame assembly by transitioning the grasping assembly from the open configuration to the closed configuration such that the at least one lower hook grasps the lower grabbable element and the at least one upper hook grasps the upper grabbable element.

2. The accessory mounting assembly of claim 1, wherein each of the lower grabbable element and the upper grabbable element extend laterally in a linear direction and have a substantially consistent cross section.

3. The accessory mounting assembly of claim 2, wherein the substantially consistent cross section of the lower grabbable element is substantially square and the substantially consistent cross section of the upper grabbable element is circular.

4. The accessory mounting assembly of claim 2, wherein the at least one locating feature is a sloped element adjacent one of the upper grabbable element or the lower grabbable element, and wherein, upon transitioning the grasping assembly from the open configuration to the closed configuration, one of the at least one lower hook or the at least one upper hook contacts the at least one locating feature prior to contacting the corresponding grabbable element, such that the grasping assembly is forced to move laterally prior to completing the transition.

5. The accessory mounting assembly of claim 4, wherein the at least one locating feature is two locating features located adjacent opposite ends of the upper grabbable element, and wherein each locating feature is sloped towards a center of the upper grabbable element.

6. The accessory mounting assembly of claim 5, wherein the at least one upper hook is two upper hooks spaced apart from each other laterally, and wherein a space between outer surfaces of the two upper hooks corresponds substantially to a space between the two locating features, and wherein when the grasping assembly is in the closed configuration and mounted on the frame assembly, each upper hook grasps the upper grabbable element and is located adjacent the corresponding locating feature.

7. The accessory mounting assembly of claim 2, wherein the at least one lower hook is two lower hooks spaced apart from each other laterally, and wherein when the grasping assembly is in the closed position and mounted on the frame assembly, each lower hook grasps the lower grabbable element and is located adjacent opposite ends of the lower grabbable element.

8. The accessory mounting assembly of claim 7, wherein the frame assembly further comprises side panels locating the lower grabbable element relative to the upper grabbable element, wherein the side panels define lateral ends of the lower grabbable element and the upper grabbable element, wherein each of the two lower hooks comprise a sloped surface angled in opposite directions, and wherein upon transitioning the grasping assembly from the open configuration to the closed configuration, the sloped surface of one of the two lower hooks contacts a corresponding side panel prior to contacting the lower grabbable element, such that the grasping assembly is forced to move laterally prior to completing the transition.

9. The accessory mounting assembly of claim 8, wherein the at least one locating feature is two sloped elements adjacent opposite ends of the upper grabbable element, each adjacent the corresponding side panel, and wherein, upon transitioning the grasping assembly from the open configuration to the closed configuration, the at least one upper hook contacts one of the two sloped elements prior to contacting upper grabbable element, such that the grasping assembly is forced to move laterally by the combination of the corresponding sloped element and the sloped surface of one of the two lower hooks prior to completing the transition.

10. The accessory mounting assembly of claim 1 further comprising an accessory fixed to the grasping assembly by way of the accessory mount.

11. The accessory mounting assembly of claim 10, wherein the accessory is a plow.

12. The accessory mounting assembly of claim 10, wherein the accessory is fixed to the grasping assembly by way of a rotatable connection, the rotatable connection allowing the accessory to pivot laterally relative to the vehicle.

13. The accessory mounting assembly of claim 12 further comprising a pair of linear actuators extending from opposite sides of the grasping assembly to opposite sides of the accessory at the rotatable connection, wherein actuation of the linear actuators effectuates a lateral pivot of the accessory.

14. The accessory mounting assembly of claim 10, wherein when the frame assembly is mounted to a vehicle and when the grasping assembly is in a closed configuration and grasping the grabbable elements, the accessory is suspended relative to a surface.

15. The accessory mounting assembly of claim 10, wherein the accessory is fixed to the grasping assembly by way of the accessory mount, wherein the accessory mount comprises a truss structure extending from the grasping assembly to an accessory mount location and for spacing the accessory apart from the grasping assembly.

16. The accessory mounting assembly of claim 15
wherein the truss structure is rotatably fixed to the grasping assembly such that pivoting the truss structure relative to the grasping assembly raises or lowers the accessory fixed thereto.

17. The accessory mounting assembly of claim 16 wherein the truss structure extends substantially horizontally from the grasping assembly and pivots relative thereto.

18. The accessory mounting assembly of claim 16
wherein the accessory is fixed to the truss structure at the accessory mount by way of a rotatable connection, the rotatable connection allowing a plow blade to pivot laterally relative to the vehicle.

19. The accessory mounting assembly of claim 16
wherein the truss structure extends from a bottom of the grasping assembly and further comprising a lift unit extending from a top of the grasping assembly to the truss structure adjacent the accessory mounting location, and wherein the lift unit pivots the truss structure relative to the grasping assembly.

20. The accessory mounting assembly of claim 19, wherein the lift unit is hydraulically operated.

21. The accessory mounting assembly of claim 1, wherein a transition between the open and closed configurations is actuated by a hydraulically operated piston.

22. The accessory mounting assembly of claim 1, wherein at least one of the at least one lower hook and the at least one upper hook further comprises a protective insert formed from a low friction material for engagement with the corresponding grabbable element.

23. A method for mounting an accessory to a vehicle comprising:
fixing a frame assembly semi-permanently to a vehicle at a vehicle fixation portion of the frame assembly, the frame assembly further comprising an accessory mounting portion having a lower grabbable element and an upper grabbable element substantially parallel to and spaced apart from the lower grabbable element by a first distance;
providing at least one locating feature at the accessory mounting portion, the locating feature comprising a sloped element adjacent one of the upper grabbable element or the lower grabbable element;
providing a grasping assembly having at least one lower hook for grasping the lower grabbable element and at least one upper hook for grasping the upper grabbable element;
providing an accessory fixed to the grasping assembly;
positioning the grasping assembly in an open configuration in which a point of the at least one lower hook is spaced apart from a point of the at least one upper hook by a second distance larger than the first distance;
operating the vehicle so as to position the lower grabbable element and the upper grabbable element of the accessory mounting portion of the frame assembly between the at least one lower hook and the at least one upper hook;
actuating a transition of the grasping assembly to a closed configuration in which the point of the at least one lower hook is spaced apart from the point of the at least one upper hook by a third distance smaller than the first distance;
causing the at least one lower hook or the at least one upper hook to impact the at least one locating feature, thereby forcing the grasping assembly to shift laterally;
continuing to transition the grasping assembly to the closed configuration until the at least one lower hook grasps the lower grabbable element and the at least one upper hook grasps the upper grabbable element.

24. The method of claim 23, wherein the transition of the grasping assembly to the closed configuration raises the accessory off of a surface on which it was resting.

25. The method of claim 23 wherein the accessory is a plow.

26. The method of claim 23 wherein each of the lower grabbable element and the upper grabbable element extend laterally in a linear direction and have a substantially consistent cross section.

27. The method of claim 26, wherein the at least one locating feature is two locating features located adjacent opposite ends of the upper grabbable element, and wherein each locating feature is sloped towards a center of the upper grabbable element.

28. The method of claim 27, wherein the at least one upper hook is two upper hooks spaced apart from each other laterally, and wherein a space between outer surfaces of the two upper hooks corresponds substantially to a space between the two locating features, and wherein when the grasping assembly is in the closed position and mounted on the frame assembly, each upper hook grasps the upper grabbable element and is located adjacent the corresponding locating feature.

29. The method of claim 26, wherein the at least one lower hook is two lower hooks spaced apart from each other laterally, and wherein when the grasping assembly is in the closed position and mounted on the frame assembly, each lower hook grasps the lower grabbable element and is located adjacent opposite ends of the lower grabbable element.

30. The method of claim 29, wherein the frame assembly further comprises side panels locating the lower grabbable element relative to the upper grabbable element, wherein the side panels define lateral ends of the lower grabbable element and the upper grabbable element, wherein each of the two lower hooks comprise a sloped surface angled in opposite directions, and wherein upon transitioning the grasping assembly from the open configuration to the closed configuration, the sloped surface of one of the two lower hooks contacts a corresponding side panel prior to contacting the lower grabbable element, thereby forcing the grasping assembly to move laterally prior to completing the transition.
